(19) United States
(12) Patent Application Publication
(10) Pub. No.: US 2002/0015491 A1
(43) Pub. Date: Feb. 7, 2002

(54) Public key encryption method and communication system using public key cryptosystem

(76) Inventors: Mototsugu Nishioka, Yokohama (JP); Hisayoshi Sato, Yokohama (JP); Hisashi Umeki, Kawasaki (JP); Yoichi Seto, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/828,213

(22) Filed: Apr. 9, 2001

(30) Foreign Application Priority Data
Jul. 5, 2000 (JP) 2000-208237

(51) Int. Cl. H04L 9/00

(52) U.S. Cl. 380/30; 708/492

(57) ABSTRACT

A cipher communication method by public key cryptosystem, being provably secure and highly efficient, wherein a sender generates ciphertext within a sender device using a receiver's public key and sends the ciphertext over a communication line, and a receiver decrypts the ciphertext using a secret key. For n=p^{d}q (p and q are prime integers, and pq is k bits), a plaintext space is set to be a subset of an open set (0,2^{k-2}) and small residue groups, and an algorithm is formed so that the relationship among solutions of plural second-order equations can be clarified. This has enabled security to be proved by equivalence with the difficulty of the problem of prime factorization, and has achieved faster decryption processing, compared with conventional methods.

### BACKGROUND OF THE INVENTION

The present invention relates to a cipher communication method and a key sharing method that uses public key cryptosystem.

Various public key encryption schemes have been so far proposed. Of these, a method described in document 1, “R. L. Rivest, A. Shamir, L. Adleman: A method for obtaining digital signatures and public-key cryptosystems, Commun. of the ACM, Vol. 21, No.2, pp. 120-126, 1978” is the most famous and most practically used public key cryptosystem. Additionally, methods using elliptic curves, described in document 2 “V. S. Miller: Use of Elliptic Curves in Cryptography, Proc. of Crypto '85, LNCS218, Springer-Verlag, pp. 417-426 (1985)”, and document 3 “N. Koblitz: Elliptic Curve Cryptosystems, Math. Comp., 48, 177, pp. 203-209 (1987)”, etc., are known as efficient public key cryptosystems.

Known encryption methods provably secure against chosen plaintext attacks include those described in: document 4 “M. O. Rabin: Digital Signatures and Public-Key Encryptions as Intractable as Factorization, MIT, Technical Report, MIT/LCS/TR-212 (1979); document 5 “T. ElGamal: A Public Key Cryptosystem and a Signature Scheme Based on Discrete Logarithms, IEEE Trans. On Information Theory, IT-31, 4, pp. 469-472 (1985)”; document 6 “S. Goldwasser and S. Micali: Probabilistic Encryption, JCSS, 28, 2, pp. 270-299 (1984)”; document 7 “M. Blum and S. Goldwasser: An Efficient probabilistic public-key encryption scheme which hides all partial information, Proc. of Crypto '84, LNCS196, Springer-Verlag, pp.289-299 (1985); document 8 “S. Goldwasser and M. Bellare: Lecture Notes on Cryptography, http:/www-cse.ucsd.edu/users/mihir/(1997)”; and document 9 “T. Okamoto and S. Uchiyama: A New Public-Key Cryptosystem as Secure as Factoring, Proc. of Eurocrypt '98, LNCS1403, Springer Verlag, pp. 308-318 (1998)”. Known encryption methods provably secure against chosen ciphertext attacks include those described in: document 10 “D. Dolve, C. Dwork and M. Naor: Non-malleable cryptography, In 23^{rd} Annual ACM Symposium On Theory of Computing, pp. 542-552 (1991)”; document 11 “M. Naor and M. Yung: Public-key cryptosystems provably secure against chosen ciphertext attacks, Proc. of STOC, ACM Press, pp. 427-437 (1990)”; document 12 “M. Bellare and P. Rogaway, Optimal Asymmetric Encryption How to Encrypt with RSA, Proc. of Eurocrypt '94, LNCS950, Springer Verlag, pp. 92-111 (1994)”; and document 13 “R. Cramer and V. Shoup: A Practical Public Key Cryptosystem Provably Secure against Adaptive Chosen Ciphertext Attack, Proc. of Crypto98, LNCS1462, Springer-Verlag, pp. 13-25 (1998)”.

In document 14 “M. Bellare, A. Desai, D. Pointcheval and P. Rogaway.: Relations Among Nations of Security for Public-Key Encryption Schemes, Proc. of Crypto '98, LNCS1462, Springer Verlag, pp. 26-45 (1998)”, there is shown the equivalence between IND-CCA2 (indistinguishable against adaptive chosen ciphertext attacks) and NM-CCA2 (non-malleable against adaptive chosen ciphertext attacks). Presently, public key cryptosystem satisfying this condition is considered to be the most secure.

### SUMMARY OF THE INVENTION

The present invention provides a public key encryption method that is provably secure and excellent in the efficiency of encryption and decryption processing.

The present invention first provides a public key encryption method that is provably OW-CPA (unidirectional for chosen plaintext attacks), under the assumption that the prime factorization problem is computationally intractable. The present invention also provides a public key encryption method that is provably IND-CCA2 (or NM-CCA2) which is based on this method.

These encryption methods are smaller in the number of modular multiplications required in encryption and decryption processing than conventional methods, enabling high-speed processing.

Also, the present invention provides an encryption method and a decryption method using public key cryptosystem which produce a small amount of computational load in encrypting send data and decrypting encrypted data and enables high-speed processing for devices with limited computational capability such as portable information processing equipment, a key distribution method and a key sharing method using these methods, and programs, devices, or systems that implement the methods.

The present invention is performed as follows.

(1) As n=p^{d}q (d is an odd number satisfying d>1), for the bit length k of pq, a small plaintext space is selected so as to be an open set (0, 2^{k-2}).

(2) On a residue group modulo a composite number (a number consisting of products of plural mutually different prime integers), there are four or more square roots, and by putting the solutions of these square roots to good use, n can be factorized into prime integers. Taking advantage of this fact, the public key encryption method of the present invention builds a procedure for encryption and decryption so as to be provably secure for chosen plaintext attacks(OW-CPA), under the assumption that the problem of prime factorization is intractable.

(3) For a public key encryption method by the above (1) and (2), the transformation method described in the document 12 is executed for transformation into a method having more powerful security, under the assumption that (ideal) random functions are publicized.

As one concrete method,

[Key Generation]

a secret key (private key) (p,q,β) satisfying

p, q: prime integers, p≡3 (mod 4), q≡3 (mod 4)

βεZ, αβ≡1 (mod lcm(p−1,q−1))

is generated, and a public key (n,k,k₀,k₁,α,G,H) satisfying

n=p^{d}q (d>1 is odd)

k, k₀, k₁: k is a binary length of pq, and k₀, k₁ are positive integers with k>k₀−k₁−2.

αεZ

G: {0,1}^{k}^{₀}→{0,1}^{k-k}^{₀}⁻²

H: {0,1}^{k-k}^{₀}⁻²→{0,1}^{k}^{₀}

is generated.

[Encryption]

A sender device computes

x=(m0^{k}^{₁}⊙G(r))∥(r⊙H(m0^{k}^{₁}⊙G(r)))

where a circled dot denotes “exclusive OR”

for plaintext m (mε{0,1}¹,1=k−k₀−k₁−2) and a random number r(rε{0,1}^{k0}},

C=x^{2nα} mod n

further computes

and further computes Jacobi's symbol a=(x/n), and sends ciphertext (C,a) to the receiver device.

[Decryption]

$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$

The receiver device computes

from the ciphertext (C,a), using a receiver's secret key (private key) (p,q,β),

and computes y that satisfies (y/n)=a and 0<y<2^{k-2} of φ(x_{1,p},x_{1,q}), φ(−x_{1,p},x_{1,q}), φ(x_{1,p},−x_{1,q}), and φ(−x_{1,p},−x_{1,q}), where φ denotes ring isomorphism mapping from Z/(p)×Z/(q) to Z/(pq) by the Chinese remainder theorem. Furthermore,

when

y=s∥t (sε{0,1}^{k-k}^{₀}⁻², tε{0,1}^{k}^{₀})

the receiver device computes

z=G(H(s)⊙t)⊙s,

$$m = \{ \begin{matrix}{[ z ]}^{l} & {if [ z ]}_{{k}_{1}} = {0}^{{k}_{1}} \\ “ reject ” & otherwise\end{matrix}$$

and decrypts the plaintext m by

where [a]^{k} and [a]ₖ denote first k-bits and last k-bits of a, respectively.

These and other benefits are described throughout the present specification. A further understanding of the nature and advantages of the invention may be realized by reference to the remaining portions of the specification and the attached drawings.

### BRIEF DESCRIPTION OF THE DRAWINGS

Preferred embodiments of the present invention will be described in detail based on the followings, wherein:

FIG. 1 is a diagram showing the system configuration of embodiments of the present invention;

FIG. 2 is a diagram showing the internal configuration of a sender device in embodiments of the present invention;

FIG. 3 is a diagram showing the internal configuration of a receiver device in embodiments of the present invention;

FIG. 4 is a diagram showing the internal configuration of a storage medium with a computing function in embodiments of the present invention;

FIG. 5 is a diagram showing the outline of a first embodiment example;

FIG. 6 is a diagram showing the outline of a sixth embodiment example;

FIG. 7 is a diagram showing the outline of a seventh embodiment example;

FIG. 8 is a diagram showing the outline of a ninth embodiment example;

FIG. 9 is a diagram showing the outline of an eleventh embodiment example; and

FIG. 10 shows comparisons between the method of an eleventh embodiment example (α=β=1) and a typical practical public key encryption method in efficiency (the number of modular products) and security.

### DETAILED DESCRIPTION OF THE PREFERRED EMBODIMENTS

Hereinafter, embodiment examples of the present invention will be described with reference to the accompanying drawings.

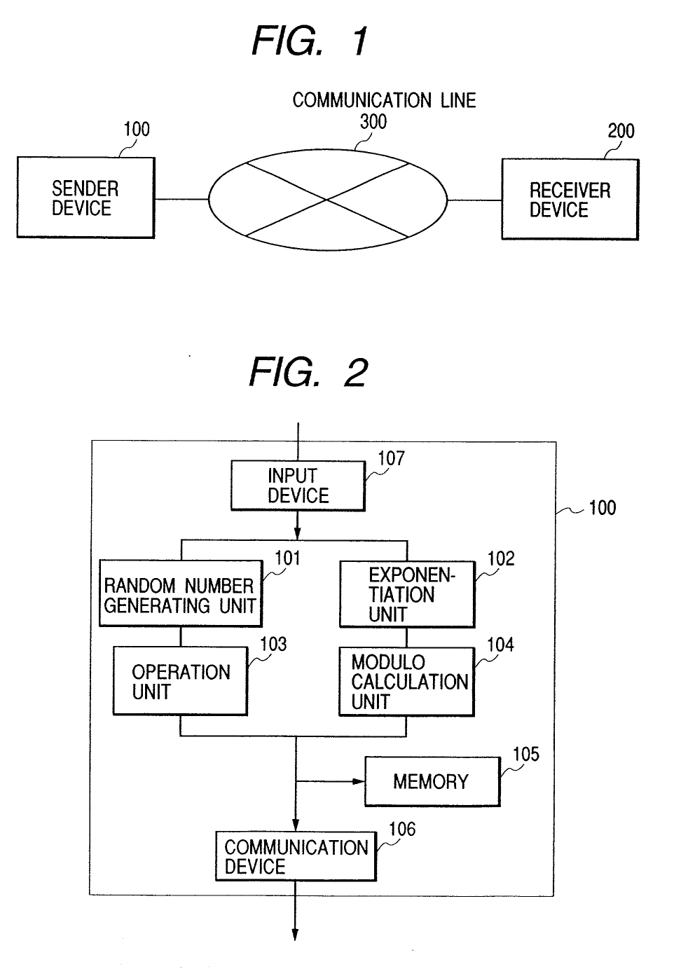

As shown in FIG. 1, a system of embodiment examples of the present invention includes a sender device 100 and a receiver device 200. Further, the sender device 100 and the receiver device are connected over a communication line 300.

As shown in FIG. 2, the sender device includes a random number generating unit 101, an exponentiation unit 102, an operation unit 103, a modulo calculation unit 104, a memory 105, a communication device 106, and an input device 107.

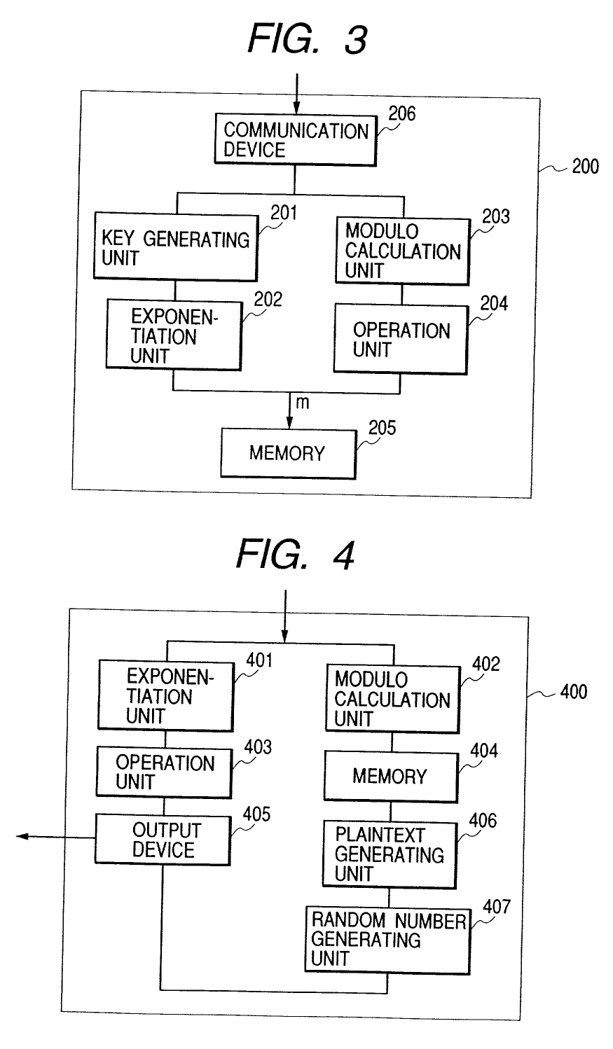

As shown in FIG. 3, the receiver device 200 includes a key generating unit 201, an exponentiation unit 202, a modulo calculation unit 203, an operation unit 204, a memory 205, and a communication device 206.

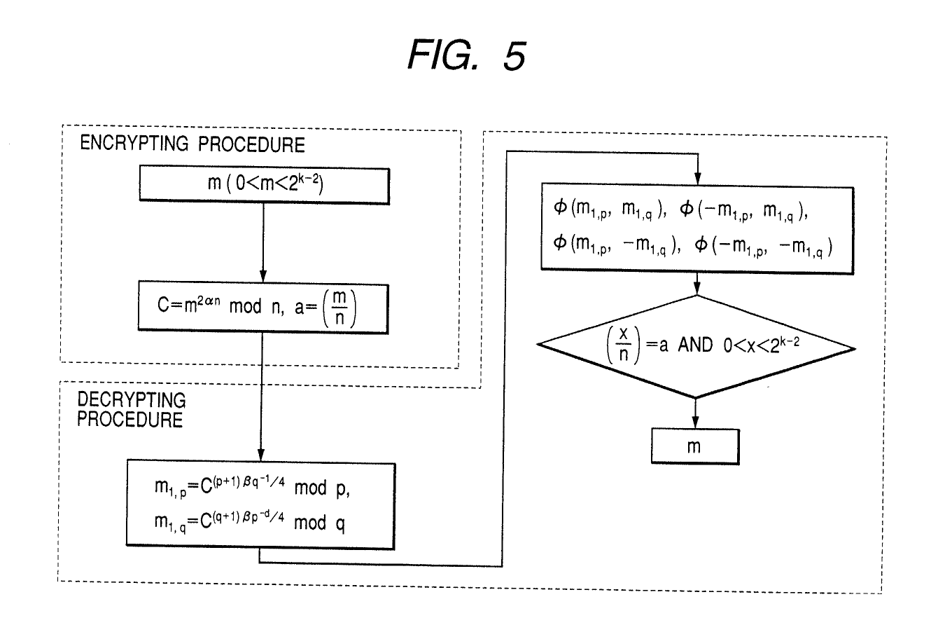

As shown in FIG. 4, a storage medium with a computing function 400 includes an exponentiation unit 401, a modulo calculation unit 402, an operation unit 403, a memory 404, an output device 405, a plaintext creating unit 406, and a random number generating unit 407.

Any of the sender device 100, the receiver device 200, and the storage medium with a computing function 400 can be constructed using a computer having a CPU and a memory. Any of the random number generating unit, the key generating unit, the power computing unit, the modulo calculation unit, the plaintext creating unit, and the random number generating unit may be constructed with dedicated hardware or as a program running on an operation unit (CPU). The programs are embodied on computer-readable media such as portable storage media and communication media on a communication line, and are stored in a computer memory through the media.

### First Embodiment Example

In the present embodiment example, a message sender A sends send data m to a receiver B over cipher communications.

FIG. 1 shows the system configuration of the present embodiment example. FIG. 5 outlines this embodiment example.

1. Key Generation Processing

The receiver B in advance generates secret information (p,q,β) satisfying

p, q: prime integers, p≡3 (mod 4), q≡3 (mod 4)

βεZ, αβ≡1 (mod lcm(p−1,q−1))

by using the key generating unit 201 within the receiver device 200, generates public information (n,k,α) (k denotes the bit length of pq) satisfying

n=p^{d}q (d>1 is odd)

k: binary length of pq

αεZ

and outputs the public information over the communication line 300 to send it to the sender device 100 or publicize it. The public information can be publicized using a known method such as, e.g., registration to a third party (public information managing institution). Other information is stored in the memory 205.

2. Encryption and Decryption Processing

(1) The sender A computes

C=m^{2nα} mod n

by using the operation unit 103, the power computing unit 102, and the modulo calculation unit 104 within the sender device 100 for plaintext m (0<m<2^{K-2}).

Furthermore, the sender A obtains the above public information from the receiver B and computes Jacobi's symbol a=(m/n) using the operation unit 103 within the sender device 100 (the definition and computation method of the Jacobi's symbol are described in, e.g., Teiji Takagi, “Elementary Number System”, Iwanami Shoten, Publishers).

Furthermore, the sender A sends ciphertext (C,a) to the receiver device 200 of the receiver B over the communication line 300, using the communication device 106.

$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$

(2) The receiver B computes from the ciphertext (C,a), using the above described secret information (p,q,β) held, and the power computing unit 202, the modulo calculation unit 203, and the operation unit 204 within the receiver device 200, and regards as the plaintext m any of φ(m_{1,p},m_{1,q}), φ(−m_{1,p},m_{1,q}), φ(m_{1,p}, m_{1,q}), and φ(−m_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem.

In the above described public key encryption method, with α and β each set equal to 1, by deleting α and β from public key and secret key respectively, key information in the method of the present embodiment example can be reduced.

Secret keys p and q can also be generated from expressions p=2p′+1 and q=2q′+1, where p′ and q′ are prime integers.

In the public key encryption method of the present embodiment example, the value of d (d>1) is changeable depending on a system. Thereby, where the bit length of plaintext m is always small, decryption processing can be performed rapidly by increasing the range of d in a range in which prime factorization of n is intractable.

According to a method in the present embodiment example, for example, when d=3, it can be proved that perfect decryption is impossible, under the assumption that the problem of prime factorization of n is intractable. Namely, if an algorithm for solving the problem of prime factorization of n is available, the algorithm could be used to form an algorithm for perfect decryption.

### Second Embodiment Example

In this embodiment example, a, which is part of ciphertext in the first embodiment example, is used as a public key.

FIG. 1 shows the system configuration of this embodiment example.

1. Key Generation Processing

The receiver B in advance generates secret information (p,q,β)

satisfying

p, q: prime integers, p≡3 (mod 4), q≡3 (mod 4)

βεZ, αβ≡1 (mod lcm(p−1,q−1))

by using the key generating unit 201 within the receiver device 200, generates public information (n,k,α,a) (k denotes the bit length of pq)

n=p^{d}q (d>1is odd)

k: binary length of pq

αεZ

αε{−1,1}

satisfying

and outputs the public information over the communication line 300 to send it to the sender device 100 or publicize it. The public information can be publicized using a known method such as, e.g., registration to a third party (public information managing institution). Other information is stored in the memory 205.

2. Encryption and Decryption Processing

(1) The sender A computes

C=m^{2nα} mod n

by using the operation unit 103, the power computing unit 102, and the modulo calculation unit 104 within the sender device 100 for plaintext m (0<m<2^{K-2}) satisfying a=(m/n).

Furthermore, the sender A sends ciphertext C to the receiver device 200 of the receiver B over the communication line 300, using the communication device 106.

(2) The receiver B computes

$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$

from the ciphertext (C,a), using the above described secret information (p,q,β) held, and the power computing unit 202, the modulo calculation unit 203, and the operation unit 204 within the receiver device 200, and regards as the plaintext m any of φ(m_{1,p},m_{1,q}), φ(−m_{1,p},m_{1,q}), φ(m_{1,p},−m_{1,q}), and φ(−m_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem.

In the above described public key encryption method, with α and β each set equal to 1, by deleting α and β from public key and secret key respectively, key information in the method of the present embodiment example can be reduced.

Secret keys p and q can also be generated from expressions p=2p′+1 and q=2q′+1, where p′ and q′ are prime integers.

In the public key encryption method of the present embodiment example, the value of d (d>1) is changeable depending on a system. Thereby, where the bit length of plaintext m is always small, decryption processing can be performed rapidly by increasing the range of d in a range in which prime factorization of n is intractable.

### Third Embodiment Example

In this embodiment example, a description will be made of a method of creating plaintext m so as to include check information for checking whether message text to be sent to a receiver from a sender has been correctly decrypted. It can be proved that the public key encryption method in the first and second embodiment examples is unidirectional for chosen plaintext attacks, but it is not secure against chosen ciphertext attacks. Accordingly, message text to be sent to a receiver from a sender is transformed into plaintext m whose contents are provided with predetermined redundancy, the plaintext m is encrypted by the method described in the first embodiment example (or second embodiment example), and the receiver decrypts the plaintext m by the method of the first embodiment example (or second embodiment example) and checks the predetermined redundancy (if the predetermined redundancy is not provided, it is considered that decryption was not performed correctly).

As another method, message text to be sent to a receiver from a sender is transformed into plaintext m whose contents are provided with a predetermined, meaningful message, the plaintext m is encrypted by the method described in the first embodiment example (or second embodiment example), and the receiver decrypts the plaintext m by the method of the first embodiment example (or second embodiment example) and checks the contents of the predetermined, meaningful message (if the contents of the predetermined, meaningful message do not match, it is considered that decryption was not performed correctly).

These methods provide the public key encryption method of the first and second embodiment examples with some degree of security against chosen ciphertext attacks (a method of proving security against chosen ciphertext attacks will be described in embodiment examples).

### Fourth Embodiment Example

In this embodiment example, a description will be made of a key sharing method for sharing an identical value between a sender and a receiver, using public information generated by the receiver.

1. Key Generation Processing

The receiver B in advance generates secret information (p,q,β)

p, q: prime integers, p≡3 (mod 4), q≡3 (mod 4)

βεZ, αβ≡1 (mod lcm(p−1,q−1))

satisfying

by using the key generating unit 201 within the receiver device 200, generates public information (n,k,α,f) (k denotes the bit length of pq)

satisfying

n=p^{d}q (d>1 is odd)

k: binary length of pq

αεZ

f: one-way function

and outputs the public information over the communication line 300 to send it to the sender device 100 or publicize it. The public information can be publicized using a known method such as, e.g., registration to a third party (public information managing institution). Other information is stored in the memory 205.

2. Key Distribution Processing

(1) The sender A computes

C=m^{2nα} mod n

by using the operation unit 103, the power computing unit 102, and the modulo calculation unit 104 within the sender device 100 for plaintext m (0<m<2^{K-2}).

Furthermore, the sender A obtains the above public information from a third party or the receiver B and computes Jacobi's symbol a=(m/n) using the operation unit 103.

Furthermore, the sender sends ciphertext (C,a) to the receiver device 200 of the receiver B over the communication line 300, using the communication device 106.

Also, the sender computes shared key K=f(m) using the operation unit 103 and the modulo calculation unit 104 within the sender device 100 from a unidirectional function f, which is public information.

$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$

(2) The receiver B computes

from the ciphertext (C,a), using the above described secret information (p,q,β) held, and the power computing unit 202, the modulo calculation unit 203, and the operation unit 204 within the receiver device 200, and regards as the plaintext m any of φ(m_{1,p},m_{1,q}), φ(−_{1,p},m_{1,q}), φ(m_{1,p},−m_{1,q}), and φ(−m_{1,p},−m_{1,q}) that satisfies (x/n)=a and 1<x<2^{k-2}, where φ denotes ring isomorphism mapping from Z/(p)×Z/(q) to Z/(pq) by the Chinese remainder theorem. Furthermore, the receiver B computes shared key K=f(m) using the operation unit 204, from the unidirectional function f, which is public information.

In the above described public key encryption method, with α and β each set equal to 1, by deleting α and β from public key and secret key respectively, key information in the method of the present embodiment example can be reduced.

Secret keys p and q can also be generated from expressions p=2p′+1 and q=2q′+1, where p′ and q′ are prime integers.

In the public key encryption method of the present embodiment example, the value of d (d>1) is changeable depending on a system. Thereby, where the bit length of plaintext m is always small, decryption processing can be performed rapidly by increasing the range of d in a range in which prime factorization of n is intractable.

### Fifth Embodiment Example

In this embodiment example, a, which is part of ciphertext in the first embodiment example, is used as a public key.

FIG. 1 shows the system configuration of this embodiment example.

1. Key Generation Processing

The receiver B in advance generates secret information (p,q,β)

satisfying

p, q: prime integers, p≡3 (mod 4), q≡3 (mod 4)

βεZ, αβ≡1 (mod lcm(p−1,q−1))

by using the key generating unit 201 within the receiver device 200, generates public information (n,k,α,a,f) (k denotes the bit length of pq)

n=p^{d}q (d>1 is odd)

k: binary length of pq

αεZ

αε{−1,1}

f: one-way function

satisfying

and outputs the public information over the communication line 300 to send it to the sender device 100 or publicize it. The public information can be publicized using a known method such as, e.g., registration to a third party (public information managing institution). Other information is stored in the memory 205.

2. Key Distribution Processing

(1) The sender A computes

C=m^{2nα} mod n

by using the operation unit 103, the power computing unit 102, and the modulo calculation unit 104 within the sender device 100 for plaintext m (0<m<2^{K-2}) satisfying a=(m/n) (a=(m/n) denotes Jacobi's symbol).

Furthermore, the sender sends ciphertext C to the receiver device 200 of the receiver B over the communication line 300, using the communication device 106.

Also, the sender computes shared key K=f(m) using the operation unit 103 and the modulo calculation unit 104 from the unidirectional function f, which is public information.

(2) The receiver B computes

$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$

from the ciphertext C, using the above described secret information (p,q,β) held, and the power computing unit 202, the modulo calculation unit 203, and the operation unit 204 within the receiver device 200, and regards as the plaintext m any of φ(m_{1,p},m_{1,q}), φ(−_{1,p},m_{1,q}), φ(m_{1,p},−m_{1,q}), and φ(−m_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem. Furthermore, the receiver B computes shared key K=f(m) using the operation unit 204, from the unidirectional function f, which is public information.

In the above described public key encryption method, with α and β each set equal to 1, by deleting α and β from public key and secret key respectively, key information in the method of the present embodiment example can be reduced.

Secret keys p and q can also be generated from expressions p=2p′+1 and q=2q′+1, where p′ and q′ are prime integers.

In the public key encryption method of the present embodiment example, the value of d (d>1) is changeable depending on a system. Thereby, where the bit length of plaintext m is always small, decryption processing can be performed rapidly by increasing the range of d in a range in which prime factorization of n is intractable.

### Sixth Embodiment Example

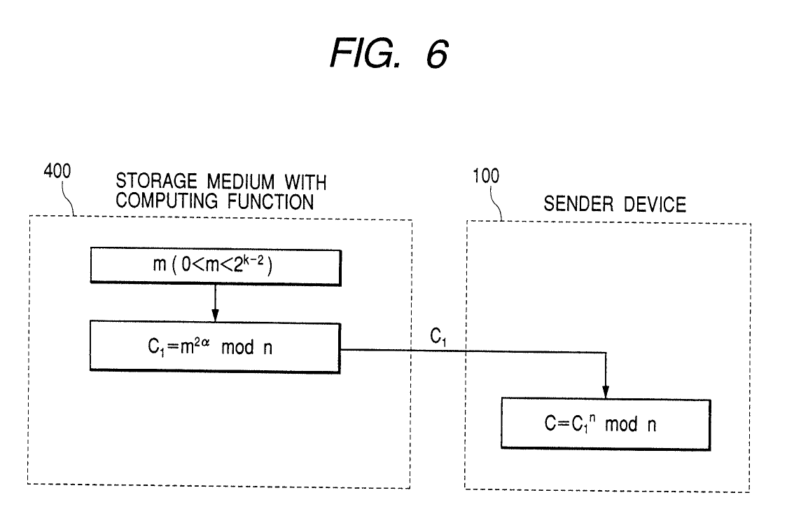

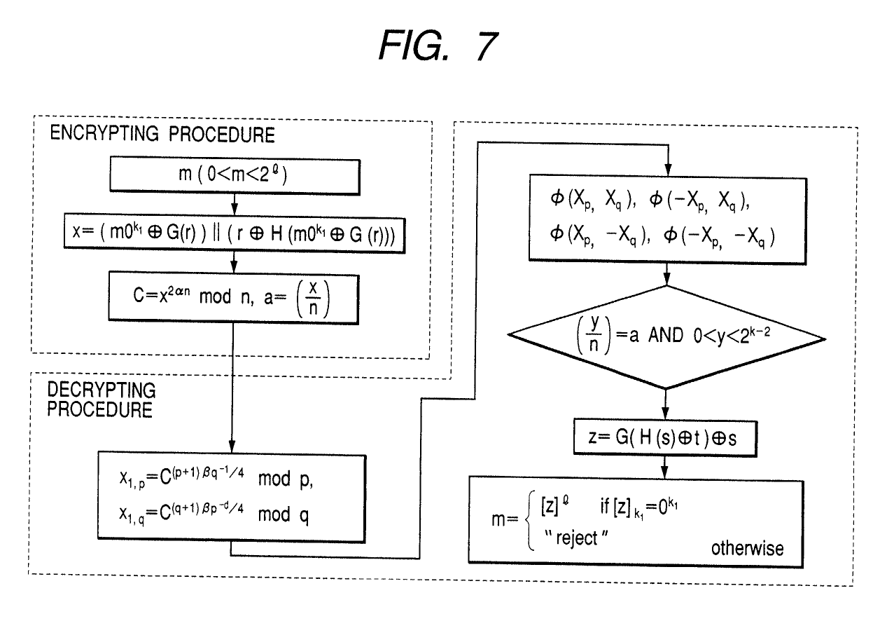

In this embodiment example, a description will be made of how the storage medium with a computing function 400 which has poor computation capability such as an IC card computes ciphertext C, using the sender device 100 having high computation capability in the first to fifth embodiment examples. FIG. 6 outlines this embodiment example.

The storage medium with a computing function 400 generates plaintext m (0<m<2^{K-2}), using the plaintext creating unit 406. Furthermore, the storage medium with a computing function 400

C₁=m^{2α} mod n

computes

using the power computing unit 401 and the modulo calculation unit 402 from the public keys α and n, and outputs it to the input device 107 of the sender device 100 from the output device 405.

The sender device 100 uses the power computing unit 202 and the

C=C₁ⁿ mod n

modulo calculation unit 203 to compute ciphertext C by

### Seventh Embodiment Example

In this embodiment example, by the transformation method described in the document 12 (described in “Prior Art”), the public key encryption method of the first embodiment example is transformed into a public key encryption method provably secure against adaptive chosen ciphertext attacks.

FIG. 1 shows the system configuration of this embodiment example. FIG. 7 outlines this embodiment example.

1. Key Generation Processing

The receiver B in advance generates secret information (p,q,β)

satisfying

p, q: prime integers, p≡3 (mod 4), q≡3 (mod 4)

βεZ, αβ≡1 (mod lcm(p−1,q−1))

by using the key generating unit 201 within the receiver device 200, generates public information (n,k,k₀,k₁,α,G,H) (k denotes the bit length of pq) satisfying

n=p^{d}q (d>1 is odd)

k, k₀, k₁: k is a binary length of pq, and k₀, k₁ are positive integers with k>k₀−k₁−2.

αεZ

G: {0,1}^{k}^{₀}→{0,1}^{k-k}^{₀}−2

H: {0,1}^{k-k}^{₀}⁻²→{0,1}^{k}^{₀}

and outputs the public information over the communication line 300 to send it to the sender device 100 or publicize it. The public information can be publicized using a known method such as, e.g., registration to a third party (public information managing institution). Other information is stored in the memory 205.

2. Encryption and Decryption Processing

(1) The sender A selects a random number r(rε{0,1}^{k0}} for plaintext m (mε{0,1}¹, 1=k−k₀−k₁−2) by using the random number generating unit 101, uses the operation unit 103 within the sender device 100 to compute

x=(m0^{k}^{₁}⊙G(r))∥(r⊙H(m0^{k}^{₁}⊙G(r)))

and further uses the operation unit 103, the power computing unit 102,

C=x^{2nα} mod n

and the modulo calculation unit 104 to compute

Furthermore, the sender A obtains the above public information from a third party or the receiver B and computes Jacobi's symbol a=(x/n) using the operation unit 103.

Furthermore, the sender A sends ciphertext (C,a) to the receiver device 200 of the receiver B over the communication line 300, using the communication device 106.

(2) The receiver B computes

$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$

from the ciphertext (C,a), using the above described secret information (p,q,β) held, and the power computing unit 202, the modulo calculation unit 203, and the operation unit 204 within the receiver device 200, and computes y that satisfies (y/n)=a and 0<y<2^{k-2} of φ(−x_{1,p},x_{1,q}), φ(−x_{1,p},x_{1,q}), φ(x_{1,p},−x_{1,q}), and φ(−x_{1,p},−x_{1,q}), where φ denotes ring isomorphism mapping from Z/(p)×Z/(q) to Z/(pq) by the Chinese remainder theorem.

Furthermore, when

y=s∥t (\dot{s}ε{0,1}^{k-k}^{₀}⁻², tε{0,1}^{k}^{₀})

z=G(H(s)⊙t)⊙s,

the operation unit 204 is used to compute

$$m = \{ \begin{matrix}{[ z ]}^{l} & {if [ z ]}_{{k}_{1}} = {0}^{{k}_{1}} \\ “ reject ” & otherwise\end{matrix}$$

and by

the plaintext m is decrypted, where [a]^{k} and [a]ₖ denote first k-bits and last k-bits of a, respectively.

By using the above described method, for example, when d=3, it can be proved by equivalence with the difficulty of the problem of prime factorization of n that the public key encryption method is provably secure against adaptive chosen ciphertext attacks (Proved for general trapdoor substitutions in the document 12).

According to the method of the present embodiment example, decryption processing is performed on a multiplication ring decided from a residue ring modulo pq, which is smaller than n, thereby achieving faster processing in comparison with conventional methods.

In the above described public key encryption method, with α and β each set equal to 1, by deleting α and β from public key and secret key respectively, key information in the method of the present embodiment example can be reduced.

Secret keys p and q can also be generated from expressions p=2p′+1 and q=2q′+1, where p′ and q′ are prime integers.

In the public key encryption method of the present embodiment example, the value of d (d>1) is changeable depending on a system. Thereby, where the bit length of plaintext m is always small, decryption processing can be performed rapidly by increasing the range of d in a range in which prime factorization of n is intractable.

### Eighth Embodiment Example

In this embodiment example, a, which is part of ciphertext in the seventh embodiment example, is used as a public key.

FIG. 1 shows the system configuration of this embodiment example.

1. Key Generation Processing

The receiver B in advance generates secret information (p,q,β)

p, q: prime integers, p≡3 (mod 4), q≡3 (mod 4)

βεZ, αβ≡1 (mod lcm(p−1,q−1))

satisfying

by using the key generating unit 201 within the receiver device 200, generates public information (n,k,k₀,k₁,α,a,G,H) satisfying

n=p^{d}q (d>1 is odd)

k,k₀,k₁εZ: k is a binary length of pq, and k₀,k₁ are positive integers with k>k₀−k₁−2.

αεZ

αε{−1,1}

G: {0,1}^{k}^{₀}→{0,1}^{k-k}^{₀}⁻²

H: {0,1}^{k-k}^{₀}⁻²→{0,1}^{₀}

and outputs the public information over the communication line 300 to send it to the sender device 100 or publicize it. The public information can be publicized using a known method such as, e.g., registration to a third party (public information managing institution). Other information is stored in the memory 205.

2. Encryption and Decryption Processing

(1) The sender A selects a random number r(rε{0,1}^{k0}} for plaintext m (mε{0,1}¹, 1=k−k₀−k₁−2) by using the random number generating unit 101, uses the operation unit 103 within the sender device 100 to compute the following expression satisfying a=(x/n)

x=(m0^{k}^{₁}⊙G(r))∥(r⊙H(m0^{k}^{₁}⊙G(r)))

and further uses the operation unit 103, the power computing unit 102, and the modulo calculation unit 104 within the sender device 100 to compute

C=x^{2nα} mod n.

Furthermore, the sender A obtains the above public information from a third party or the receiver B and computes Jacobi's symbol a=(x/n) using the operation unit 103.

Furthermore, the sender A sends the ciphertext C to the receiver device 200 of the receiver B over the communication line 300, using the communication device 106.

(2) The receiver B computes

$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$

from the ciphertext C, using the above described secret information (p,q,β) held, and the power computing unit 202, the modulo calculation unit 203, and the operation unit 204 within the receiver device 200, and computes y that satisfies (y/n)=a and 0<y<2^{k-2} of φ(x_{1,p},x_{1,q}), φ(−x_{1,p},x_{1,q}), φ(x_{1,p},−x_{1,q}), and φ(−x_{1,p},−x_{1,q}), where φ denotes ring isomorphism mapping from Z/(p)×Z/(q) to Z/(pq) by the Chinese remainder theorem.

Furthermore, when

y=s∥t (sε{0,1}^{k-k}^{₀}⁻², tε{0,1}^{k}^{₀})

z=G(H(s)⊙t)⊙s,

the operation unit 204 is used to compute

$$m = \{ \begin{matrix}{[ z ]}^{l} & {if [ z ]}_{{k}_{1}} = {0}^{{k}_{1}} \\ “ reject ” & otherwise\end{matrix}$$

and by

the plaintext m is decrypted, where [a]^{k} and [a]ₖ denote first k-bits and last k-bits of a, respectively.

In the above described public key encryption method, with α and β each set equal to 1, by deleting α and β from public key and secret key respectively, key information in the method of the present embodiment example can be reduced.

Secret keys p and q can also be generated from expressions p=2p′+1 and q=2q′+1, where p′ and q′ are prime integers.

In the public key encryption method of the present embodiment example, the value of d (d>1) is changeable depending on a system. Thereby, where the bit length of plaintext m is always small, decryption processing can be performed rapidly by increasing the range of d in a range in which prime factorization of n is intractable.

### Ninth Embodiment

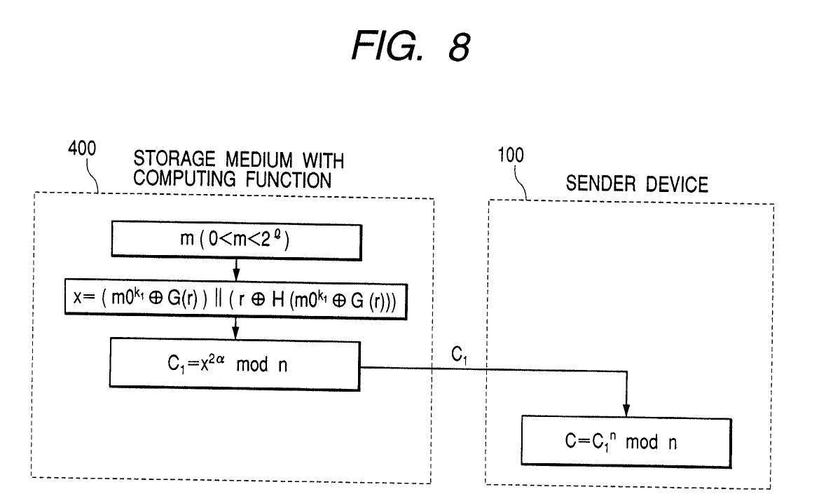

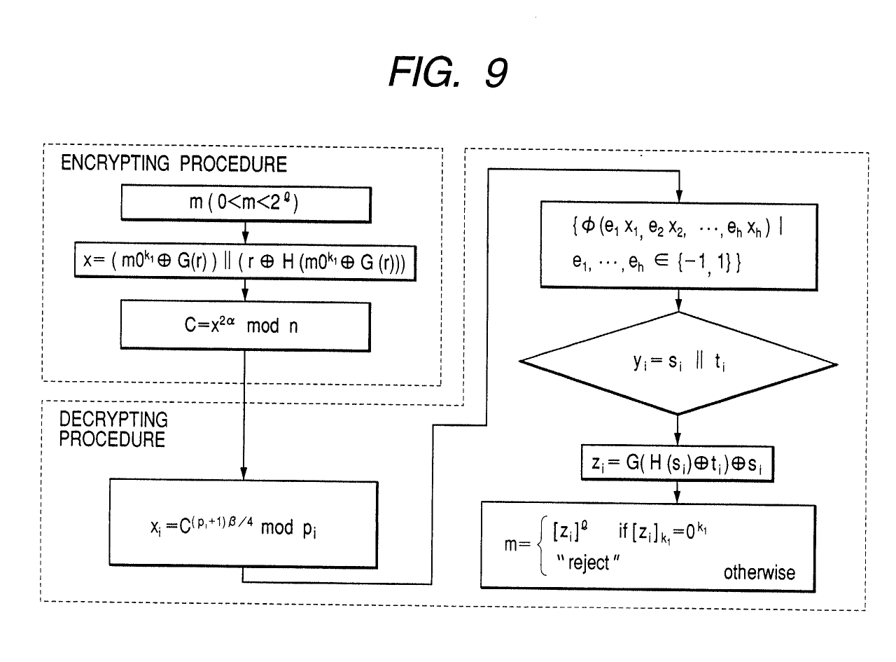

In this embodiment example, a description will be made of how the storage medium with a computing function 400 which has poor computation capability such as an IC card computes ciphertext C, using the sender device 100 having high computation capability in the seventh and eighth embodiment examples. FIG. 8 outlines this embodiment example.

The storage medium with a computing function 400 generates plaintext m (mε{0,1}¹, 1=k−k₀−k₁−2), using the plaintext creating unit 406. Furthermore, the storage medium with a computing function 400 generates a random number r (rε{0,1}^{k0}} using the random number

x=(m0^{k}^{₁}⊙G(r))∥(r⊙H(m0^{k}^{₁}⊙G(r)))

generating unit 407 and uses the operation unit 403 to compute

from functions G and H. Furthermore, the storage medium with a computing function 400 computes

C₁=x^{2α} mod n

using the power computing unit 401 and the modulo calculation unit 402 from the public keys α and n, and outputs it to the input device 107 of the sender device 100 from the output device 405.

The sender device 100 uses the power computing unit 102 and the modulo calculation unit 104 to compute ciphertext C by

C=C₁ⁿ mod n

### Tenth Embodiment

In this embodiment, a description will be made of a public key encryption method which is a variant of the public key encryption methods of the first to fifth embodiment examples and the seventh and eighth embodiment examples, and is not provably secure but is excellent in the efficiency of encryption and decryption processing.

In the first to fifth embodiment examples, the operation unit 103 within the sender device 100 is used to compute the ciphertext C by

C=m^{2α} mod n

In the first to fifth embodiment examples, the power computing unit 202, the modulo calculation unit 203, and the operation unit 204 within the receiver device 200 are used to compute m_{1,p} and m_{1,q} from the ciphertext C by

$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$

In the seventh and eighth embodiment examples, the operation unit 103 within the sender device 100 is used to compute the ciphertext C by

C=x^{2α} mod n

and in the seventh and eighth embodiment examples, the power computing unit 202, the modulo calculation unit 203, and the operation unit 204 within the receiver device 200 are used to compute m_{1,p} and m_{1,q} from the ciphertext C by

$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q .$$

### Eleventh Embodiment

In this embodiment, a description will be made of the case where identification information a is omitted in the seventh and eighth embodiments.

In this case, the sender A selects a random number r(rε{0,1}^{k0}} for plaintext m (mε{0,1}¹, 1=k−k₀−k₁−2) by using the random number generating unit 101, uses the operation unit 103 within the sender device

x=(m0^{k}^{₁}⊙G(r))∥(r⊙H(m0^{k}^{₁}G(r)))

100 to compute

and further uses the operation unit 103, the power computing unit 102, and the modulo calculation unit 104 within the sender device 100 to compute

C=x^{2nα} mod n

Furthermore, the sender A sends the ciphertext C to the receiver device 200 of the receiver B over the communication line 300, using the communication device 106.

The receiver B computes

$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$

from the ciphertext C, using the above described secret information (p,q,β) held, and the power computing unit 202, the modulo calculation unit 203, and the operation unit 204 within the receiver device 200, and for each of y₁(x_{1,p},x_{1,q}), y₂(−x_{1,p},x_{1,q}), y₃(x_{1,p},−x_{1,q}), and y₄(−x_{1,p},−x_{1,q}), when yᵢ=sᵢ∥tᵢ (sᵢε{0,1}^{k-k}^{₀}⁻², tᵢε{0,1}^{k}^{₀}, 1≦i≦4)

zᵢ=G(H(sᵢ)⊙tᵢ)⊙sᵢ (1≦i≦4),

uses the operation unit 204 to compute

and decrypts the plaintext m by

$$m = \{ \begin{matrix}{[ z ]}^{l} & {if [ z ]}_{{k}_{1}} = {0}^{{k}_{1}} \\ “ reject ” & otherwise\end{matrix}$$

φ denotes ring isomorphism mapping from Z/(p)×Z/(q) to Z/(pq) by the Chinese remainder theorem. [a]^{k} and [a]ₖ denote first k-bits and last k-bits of a, respectively.

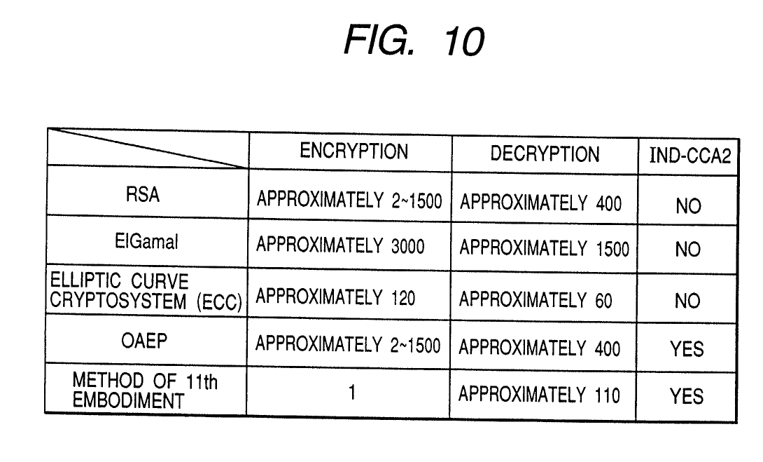

FIG. 10 shows comparisons between the method of the eleventh embodiment example and a typical practical public key encryption method in efficiency (the number of modular products) and security. In the comparisons in FIG. 10, α and β each are set equal to 1. Many of data in FIG. 10 are quoted from the document 9.

### Twelfth Embodiment Example

In this embodiment example, a description will be made of a public key encryption method by which a public key encryption method described in the document 4 is subjected to a transformation method described in the document 12 to further increase the efficiency of decryption processing.

FIG. 1 shows the system configuration of this embodiment example. FIG. 9 outlines this embodiment example.

1. Key Generation Processing

The receiver B in advance generates secret information (pᵢ,β) (1≦i≦h) satisfying

pᵢ: prime integers (pᵢ≡3 (mod 4), 1≦i≦h)

βεZ, αβ≡1 (mod lcm(p−1,q−1))

by using the key generating unit 201 within the receiver device 200, generates public information (n,k,k₀,k₁,α,G,H) satisfying

n=πᵢ₌₁^{h}pᵢ

k, k₀, k₁εZ: k is a bay length of n, and k₀, k₁ are positive integers with k>k₀−k₁−2.

G: {0,1}^{k}^{₀}→{0,1}^{k-k}^{₀}

H: {0,1}^{k-k}^{₀}→{0,1}^{k}^{₀}

and outputs the public information over the communication line 300 to send it to the sender device 100 or publicize it. The public information can be publicized using a known method such as, e.g., registration to a third party (public information managing institution). Other information is stored in the memory 205.

2. Encryption and Decryption Processing

The sender A selects a random number r(rε{0,1}^{k0}} for plaintext m If (mε{0,1}¹,1=k−k₀−k₁−2) by using the random number generating unit 101 within the sender device 100 to compute

x=(m0^{k}^{₁}⊙G(r))∥(r⊙H(m0^{k}^{₁}⊙G(r)))

and further obtains the above public information from a third party or the receiver B and uses the operation unit 103, the power computing unit 102, and the remainder computing unit 104 to compute

C=x^{2α} mod n

Furthermore, the sender A sends the ciphertext C to the receiver device 200 of the receiver B over the communication line 300, using the communication device 106.

3. Decryption Processing

$${x}_{i} = {C}^{\frac{( {p}_{i} + 1 ) β}{4}} mod {p}_{i}$$

The receiver B computes

from the ciphertext C, using the above described secret information (pᵢ,β) (1≦i≦h) held, and the power computing unit 202, the modulo calculation unit 203, and the operation unit 204 within the receiver device 200, and for 2^{h} pieces of {φ(e₁x₁,e₂x₂, . . . ,eₕxₕ)|e₁, . . . ,eₕε{−1,1}},

yᵢ=sᵢ∥tᵢ(sᵢε{0,1}^{k-k}^{₀}, tᵢε{0,1}^{k}^{₀}, 1≦i≦2^{h})

when

zᵢ=G(H(s)⊙tᵢ)⊙sᵢ (1≦i≦2^{h})

uses the operation unit 204 to compute

$$m = \{ \begin{matrix}{[ z ]}^{l} & {if [ z ]}_{{k}_{1}} = {0}^{{k}_{1}} \\ “ reject ” & otherwise\end{matrix} .$$

and decrypts the plaintext m by

φ denotes ring isomorphism mapping from Z/(p₁)×Z/(p₂)× . . . ×Z/(pₕ) to Z/(n) by the Chinese remainder theorem. [a]^{k} and [a]ₖ denote first k-bits and last k-bits of a, respectively.

In the above described public key encryption method, with α and β each set equal to 1, by deleting α and β from public key and secret key respectively, key information in the method of the present embodiment example can be reduced.

By sending identification information such as the magnitudinous relationship of x and n/2, Jacobi's symbol (x/n) together with the ciphertext (or by creating x according to identification information specified by the public information), efficiency can be increased in decrypting of correct plaintext from 2^{h} pieces of {φ(e₁x₁,e₂x₂, . . . ,eₕxₕ)|e₁, . . . ,eₕε{−1,1}}.

The method of this embodiment example solves the difficult problem of unique decryption, under the assumption that, with the conventional public key encryption method described in the document 4, security is provable in the case where n, which is part of public key, is the product of there or more mutually different prime integers.

Although the embodiment examples have been described in a general form that a sender and a receiver perform cipher communications using their respective devices, the present invention is actually applied to various systems.

For example, in an electronic shopping system, a sender is a user and a sender device is a computer such as a personal computer, while a receiver is a retail shop and a receiver device is a computer such as a personal computer. In this case, orders for user products and the like are often encrypted in common key cipher, and an encryption key used at that time is encrypted by the methods of the embodiment examples and sent to the device of the retail shop.

In an electronic mail system, respective devices are computers such as personal computers, sender's messages are often encrypted in common key cipher, and an encryption key used at that time is encrypted by the methods of the embodiment examples and sent to a receiver computer.

The present invention is applicable to other various systems in which conventional public key encryption methods are used.

Although computations in the embodiment examples are performed by the CPU executing programs within memory, besides by programs, data may be exchanged between a hard-wired computing unit and other computing units, and the CPU.

According to the present invention, there can be provided a public key encryption method and a key sharing method that are secure against chosen plaintext attacks, and the most powerful adaptive chosen ciphertext attacks, and enable high-speed processing, and devices and a system applying the methods.

The specification and drawings are, accordingly, to be regarded in an illustrative rather than a restrictive sense. It will, however, be evident that various modifications and changes may be made thereto without departing from the broader spirit and scope of the invention as set forth in the claims.

We claim:

1. A communication method using public key cryptosystem by which a sender device encrypts send data by using a receiver's public key, the method comprising:
a key generating step of generating a secret key (p,q,β) satisfying
p, q: prime integers, p≡3 (mod 4), q≡3 (mod 4)
βεZ, αβ≡1 (mod lcm(p−1,q−1))
and
n=p^{d}q (d>1 is odd.)
k binary length of pq
αεZ
a public key (n,k,α) satisfying
(1) an encrypting step performed by the sender device, of
C=m^{2nα} mod n
computing
for plaintext m (0<m<2^{k-2}), computing Jacobi's symbol a=(m/n), and sending ciphertext (C,a) to the receiver device; and
(2) a decrypting step performed by the receiver device, of using the receiver's secret key (p,q,β) to compute
$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$
from the ciphertext (C,a), and regarding as the plaintext m any of φ(m_{1,p},m_{1,q}), φ(−m_{1,p},m_{1,q}), φ(m_{1,p},−m_{1,q}), and φ(−_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem.

2. The communication method using public key cryptosystem according to claim 1, comprising the step of:
generating and publicizing the public information (n,k,α) by the receiver device.

3. The communication method using public key cryptosystem according to claim 1, wherein, for α=β=1, α and β are deleted from the public key and the secret key, respectively.

4. A communication system using public key cryptosystem in which a sender device encrypts send data by using a receiver's public key, the system comprising:
(a) a sender device comprising:
a key generating device for generating a secret key (p,q,β) satisfying
p, q: prime integers, p≡3 (mod 4), q≡3 (mod 4)
βεZ, αβ≡1 (mod lcm(p−1,q−1))
and
n=p^{d}q (d>1 is odd)
k: binary length of pq
αεZ
aε{−1,1}
a public key (n,k,α,a) (k is the bit length of pq) satisfying
a device for computing
C=m^{2nα} mod n
for plaintext m satisfying a=(m/n) (0<m<2^{k-2}) (a=(m/n denotes Jacobi's symbol); and
a communication device for sending ciphertext C to the receiver device; and
(b) a receiver device comprising:
$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$
a device using the receiver's secret key (p,q,β) to compute from the ciphertext C; and
a device regarding as the plaintext m any of φ(m_{1,p},m_{1,q}), φ(−m_{1,p},m_{1,q}), φ(m_{1,p},−m_{1,q}), and φ(−m_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem.

5. The communication system using public key cryptosystem according to claim 4, wherein the receiver device comprises a device for creating the public information (n,k,α,a).

6. The communication system using public key cryptosystem according to claim 4, wherein, for α=β=1, α and β are deleted from the public key and the secret key, respectively.

7. The communication method using public key cryptosystem according to claim 1, comprising the step of creating the secret keys p and q by p=2p′+1 and q=2q′+1, where p′ and q′ are prime integers.

8. The communication method using public key cryptosystem according to claim 1, comprising the step of creating the plain text m so as to include check information for checking whether message text to be sent to the receiver from the sender has been correctly decrypted.

9. The communication method using public key cryptosystem according to claim 1, comprising the step of transforming message text to be sent to the receiver from the sender into plaintext m whose contents are provided with predetermined redundancy, and encrypting the plaintext m by the method described in claims 1 or 4, wherein the receiver device decrypts the plaintext m by the method described in claims 1 or 4 and checks the predetermined redundancy.

10. The communication method using public key cryptosystem according to claim 1, comprising the step of transforming message text to be sent to the receiver from the sender into plaintext m whose contents are provided with a predetermined, meaningful message, and encrypting the plaintext m by the method described in claims 1 or 4, wherein the receiver device decrypts the plaintext m by the method described in claims 1 or 4 and checks the contents of the predetermined, meaningful message.

11. The communication method using public key cryptosystem according to claim 1, wherein the value of d (d>1) is variable.

12. A key sharing method by which a sender device performs cipher communications by using a receiver's public key, the method comprising key generating steps of:
generating a secret key (p,q,β) satisfying
p, q: prime integers, p≡3 (mod 4), q≡3 (mod 4)
βεZ, αβ≡1 (mod lcm(p−1,q−1))
and
a public key (n,k,α) (k is the bit length of pq) satisfying
n=p^{d}q (d>1 is odd)
k: binary length of pq
αεZ
f: one-way function
(1) in the sender device, to share a shared key K=f(m) with the
C=m^{2nα} mod n
receiver device, for send data m (0<m<2^{k-2}), computing
and
computing Jacobi's symbol a=(m/n) and the shared key K by K=f(m), sending ciphertext (C,a) to the receiver device, and computing the shared key K=f(m); and
(2) in the receiver device, using the receiver's secret key (p,q,β) to compute
$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$
from the ciphertext (C,a), computing as the send data m any of φ(m_{1,p},m_{1,q}), φ(−m_{1,p},m_{1,q}), φ(m_{1,p},−m_{1,q}), and φ(−m_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem, and computing the shared key K by K=f(m) using public information f.

13. The key sharing method according to claim 12, comprising the step of:
generating and publicizing the public information (n,k,α) by the receiver device.

14. The key sharing method according to claim 12, wherein, for α=β=1, α and β are deleted from the public key and the secret key, respectively.

15. A key sharing method by which a sender device performs cipher communications by using a receiver's public key, the method comprising key generating steps of:
generating a secret key (p,q,β) satisfying
p, q: prime integers, p≡3 (mod 4), q≡3 (mod 4)
βεZ, αβ≡1 (mod lcm(p−1,q−1))
and
n=p^{d}q (d>1 is odd)
k: binary length of pq
αεZ
αε{−1,1}
f: one-way function
a public key (n,k,α,a) (k is the bit length of pq) satisfying
(1) in the sender device, to share a shared key K=f(m) with the receiver device, for send data m (0<m<2^{k-2}) satisfying a=(m/n) (a=(m/n) denotes Jacobi's symbol), computing
C=m^{2nα} mod n
and
computing the shared key K by K=f(m), sending ciphertext C to the receiver device, and computing the shared key K=f(m); and
(2) in the receiver device, using the receiver's secret key (p,q,β) to compute
$${m}_{1 , p} = {C}^{\frac{( p + 1 ) β {q}^{- 1}}{4}} mod p , \\ {m}_{1 , q} = {C}^{\frac{( q + 1 ) β {p}^{- d}}{4}} mod q$$
from the ciphertext C, computing as the send data m any of φ(m_{1,p},m_{1,q}), φ(−m_{1,p},m_{1,q}), φ(m_{1,p},−m_{1,q}), and φ(−m_{1,p},−m_{1,q}) that satisfies (x/n)=a and 0<x<2^{k-2}, where φ denotes ring isomorphism mapping from Z/(p)×Z/(q) to Z/(pq) by the Chinese remainder theorem, and computing the shared key K by K=f(m) using public information f.

16. The key sharing method according to claim 15, comprising the step of:
generating and publicizing the public information (n,k,α,a) by the receiver device.

17. The key sharing method according to claim 15, comprising the step of, for α=β=1, deleting α and β from the public key and the secret key, respectively.

18. The key sharing method according to claim 12, comprising the step of creating the secret keys p and q by p=2p′+1 and q=2q′+1, where p′ and q′ are prime integers.

19. The key sharing method according to claim 12, wherein the value of d (d>1) is variable.

20. An encryption method in public key cryptosystem according to claim 1, wherein one or more hash functions are publicized and the sender device comprises the steps of:
creating plaintext and random number information;
performing exclusive OR and data concatenation operations on the plaintext and the random number information;
inputting results obtained by the operations to a relevant hash function and computing the input results;
performing exclusive OR and data concatenation operations on the plaintext, the random number information, and the results of input to the hash function; and
replacing the results of the operations in a location of the plaintext m in claim 1 or the location of a random number r, and performing encryption according to the procedure of the public key cryptosystem in claim 1.

21. A decryption method in public key cryptosystem, for decrypting ciphertext encrypted by the method set forth according to claim 20, the method comprising:
the decrypting step set forth in claim 1;
a step of restoring the plaintext m from the results of the logical OR and data concatenation operations performed in claim 20;
a step of verifying the validity of the procedure of the (exclusive OR and data concatenation) operations; and
a step of outputting decryption results.

22. A communication method using public key cryptosystem by which a sender device encrypts send data by using a receiver's public key, the method comprising key generating steps of: generating a secret key (p,q,β) satisfying
p, q: prime integers, p≡3 (mod 4), q≡3 (mod 4)
βεZ, αβ≡1 (mod lcm(p−1,q−1))
and
a public key (n,k,k₀,k₁,α,G,H) satisfying
n=p^{d}q (d>1 is odd)
k, k₀, k₁: k is a binary length of pq, and k₀, k₁ are positive integers with k>k₀−k₁−2.
G: {0,1}^{k}^{₀}→{0,1}^{k-k}^{₀}⁻²
H: {0,1}^{k-k}^{₀}⁻²→{0,1}^{k}^{₀}
x=(m0^{k}^{₁}⊙G(r))∥(r⊙H(m0^{k}^{₁}⊙G(r)))
(1) in the sender device, computing
for plaintext m (mε{0,1}¹,1=k−k₀−k₁−2) and a random number r(rε{0,1}^{k0}},
C=x^{2nα} mod n
computing
and further computing Jacobi's symbol a=(x/n), and sending ciphertext (C,a) to the receiver device; and
(2) in the receiver device, using the receiver's secret key (p,q,β) to compute
$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$
from the ciphertext (C,a), computing y that satisfies (y/n)=a and 0<y<2^{k-2} of φ(x_{1,p},x_{1,q}), φ(−x_{1,p},x_{1,q}), φ(x_{1,p},−x_{1,q}), and φ(−x_{1,p},−x_{1,q}), where φ denotes ring isomorphism mapping from Z/(p)×Z/(q) to Z/(pq) by the Chinese remainder theorem, further when
y=s∥t (sε{0,1}^{k-k}^{₀}⁻², tε{0,1}^{k}^{₀})
computing
z=G(H(s)⊙t)⊙s,
$$m = \{ \begin{matrix}{[ z ]}^{l} & {if [ z ]}_{{k}_{1}} = {0}^{{k}_{1}} \\ “ reject ” & otherwise\end{matrix} ,$$
and decrypting the plaintext m by
where [a]^{k} and [a]ₖ denote first k-bits and last k-bits of a, respectively.

23. The communication method using public key cryptosystem according to claim 22, comprising the step of:
generating and publicizing the public information (n,k,k₀,k₁,α,G,H) by the receiver device.

24. The communication method using public key cryptosystem according to claim 22, comprising the step of, for α=β=1, deleting α and β from the public key and the secret key, respectively.

25. A communication method using public key cryptosystem by which a sender device encrypts send data by using a receiver's public key, the method comprising key generating steps of:
generating a secret
p, q: prime integers, p≡3 (mod 4), q≡3 (mod 4)
βεZ, αβ≡1 (mod lcm(p−1,q−1))
key (p,q,β) satisfying
and
a public key (n,k,k₀,k₁,α,G,H) satisfying
n=p^{d}q (d>1 is odd)
k, k₀,k₁εZ: k is a binary length of pq, and k₀, k₁ are positive integers with k>k₀−k₁−2.
αεZ
αε{−1,1}
G: {0,1}^{k}^{₀}→{0,1}^{k-k}^{₀}⁻²
H: {0,1}^{k-k}^{₀}⁻²→{0,1}^{k}^{₀}
(1) in the sender device, computing
x=(m0^{k}^{₁}⊙G(r))∥(r⊙H(m0^{k}^{₁}⊙G(r)))
that satisfies a=(x/n) for plaintext m (mε{0,1}¹,1=k−k₀−k₁−2) and a random number r(rε{0,1}^{k0}} (a=(m/n) denotes Jacobi's symbol), computing
C=x^{2nα} mod n
and further sending ciphertext C to the receiver device; and
(2) in the receiver device, using the receiver's secret key (p,q,β) to
$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$
compute
from the ciphertext C, computing y that satisfies (y/n)=a and 0<y<2^{k-2} of φ(x_{1,p},x_{1,q}), φ(−x_{1,p},x_{1,q}), φ(x_{1,p},−x_{1,q}), and φ(−x_{1,p},−x_{1,q}), where φ denotes ring isomorphism mapping from Z/(p)×Z/(q) to Z/(pq) by the Chinese remainder theorem, further when
y=s∥t (sε{0,1}^{k-k}^{₀}⁻², tε{0,1}^{k}^{₀}),
z=G(H(s)⊙t)⊙s,
computing
$$m = \{ \begin{matrix}{[ z ]}^{l} & {if [ z ]}_{{k}_{1}} = {0}^{{k}_{1}} \\ “ reject ” & otherwise\end{matrix}$$
and decrypting the plaintext m by
where [a]^{k} and [a]ₖ denote first k-bits and last k-bits of a, respectively.

26. The communication method using public key cryptosystem according to claim 25, comprising the step of:
generating and publicizing the public information (n,k,k₀,k₁,α,a,G,H) by the receiver device.

27. A communication method using public key cryptosystem by which a sender device encrypts send data by using a receiver's public key, the method comprising key generating steps of:
generating a secret key (p,q,β) satisfying
p, q: prime integers, p≡3 (mod 4), q≡3 (mod 4)
βεZ, αβ≡1 (mod lcm(p−1,q−1))
and
a public key (n,k,k₀,k₁,α,G,H) satisfying
n=d^{d}q (d>1 is odd)
k, k₀, k₁εZ: k is a binary length of pq, and k₀,k₁ are positive integers with k>k₀−k₁−2.
αεZ
G: {0,1}^{k}^{₀}→{0,1}^{k-k}^{₀}⁻²
H: {0,1}^{k-k}^{₀}⁻²→{0,1}^{k}^{₀}
x==(m0^{k}^{₁}⊙G(r))∥(r⊙H(m0^{k}^{₁}⊙G(r)))
(1) in the sender device, computing
for plaintext m (mε{0,1}¹,1=k−k₀−k₁−2) and a random number r(rε{0,1}^{k0}},
C=x^{2nα} mod n
computing
and sending ciphertext C to the receiver device; and
(2) in the receiver device, using the receiver's secret key (p,q,β) to compute
$${x}_{1 , p} = {C}^{\frac{( p + 1 ) β {q}^{- 1}}{4}} mod p , \\ {x}_{1 , q} = {C}^{\frac{( q + 1 ) β {p}^{- d}}{4}} mod q$$
from the ciphertext C, for y₁=φ(x_{1,p},x_{1,q}), y₂=φ(−x_{1,p},x_{1,q}), y₃=φ(x_{1,p},−x_{1,q}), and y₄=φ(−x_{1,p},−x_{1,q}), where φ denotes ring isomorphism mapping from Z/(p)×Z/(q) to Z/(pq) by the Chinese remainder theorem,
yᵢ=sᵢ∥tᵢ (sᵢε{0,1}^{k-k}^{₀}⁻², tᵢε{0,1}k^{₀}, 1≦i≦4),
when
computing
zᵢ=G(H(sᵢ)⊙tᵢ)⊙sᵢ (1≦i≦4),
$$m = \{ \begin{matrix}{[ z ]}^{l} & {if [ z ]}_{{k}_{1}} = {0}^{{k}_{1}} \\ “ reject ” & otherwise\end{matrix}$$
and decrypting the plaintext m by
where [a]^{k} and [a]ₖ denote first k-bits and last k-bits of a, respectively.

28. The communication method using public key cryptosystem according to claim 27, comprising the step of:
generating and publicizing the public information (n,k,k₀,k₁,α,G,H) by the receiver device.

29. The communication method using public key cryptosystem according to claim 22, comprising the step of, for α=β=1, deleting α and β from the public key and the secret key, respectively.

30. The communication method using public key cryptosystem according to claim 22, comprising the step of creating the secret keys p and q by p=2p′+1 and q2q′+1, where p′ and q′ are prime integers.

31. The communication method using public key cryptosystem according to claim 22, wherein the value of d (d>1) is variable.

32. An encryption method according to claim 1, for computing ciphertext C in two different devices, comprising the steps of:
C₁=m^{2α} mod n,
in a device 1, after computing outputting C₁ to a device 2; and
C=C₁ⁿ mod n
in the device 2, by computing
computing the ciphertext C.

33. An encryption method according to claim 22, for computing ciphertext C in two different devices, comprising the steps of:
x=(m0^{k}^{₁}⊙G(r))∥(r⊙H(m0^{k}^{₁}⊙G(r)))
in a device 1, computing
for plaintext m (mε{0,1}¹,1=k−k₀−k₁−2) and a random number r(rε{0,1}^{k0}},
C₁=x^{2α} mod n
and after further computing
outputting C₁ to a device 2; and
in the device 2, by computing
C=C₁ⁿ mod n
computing the ciphertext C.

34. A communication method using public key cryptosystem by which a sender device encrypts send data by using a receiver's public key, the method comprising key generating steps of:
generating a secret
pᵢ: prime integers (pᵢ≡3 (mod 4), 1≦i≦h)
βεZ, αβ≡1 (mod lcm(p−1,q−1))
key (pᵢ,β) (1≦=i≦h) satisfying
and
a public key (n,k,k₀,k₁,α,G,H) satisfying
n=πᵢ₌₁^{h}pᵢ
k, k₀, k₁εZ: k is a binary length of pq, and k₀, k₁ are positive integers with k>k₀−k₁−2
αεZ
G: {0,1}^{k}^{₀}→{0,1}^{k-k}^{₀}
H: {0,1}^{k-k}^{₀}→{0,1}^{k}^{₀}
x=(m0^{k}^{₁}⊙G(r)))∥(r⊙H(m0^{k}^{₁}⊙G(r)))
(1) in the sender device, computing
for plaintext m (mε{0,1}¹,1=k−k₀−k₁) and a random number r(rε{0,1}^{k}^{₀}},
C=x^{2α} mod n
computing
and sending ciphertext C to the receiver device; and
(2) in the receiver device, using the receiver's secret key (pᵢ,β) (1≦i≦h) to compute
$${x}_{i} = {C}^{\frac{( {p}_{i} + 1 ) β }{4}} mod {p}_{i}$$
from the ciphertext C, for 2^{h} pieces of {φ(e₁x₁,e₂x₂, . . . ,eₕxₕ)|e₁, . . . ,eₕε{−1,1}} when
yᵢ=sᵢ∥tᵢ (sᵢε{0,1}^{k-k}^{₀}, tᵢε{0,1}^{k}^{₀}, 1≦i≦2^{h})
computing
zᵢ=G(H(sᵢ)⊙tᵢ)⊙sᵢ (1≦i≦2^{h})
and decrypting the plaintext m by
$$m = \{ \begin{matrix}{[ z ]}^{l} & {if [ z ]}_{{k}_{1}} = {0}^{{k}_{1}} \\ “ reject ” & otherwise\end{matrix} ,$$
where φ denotes ring isomorphism mapping from Z/(p)×Z/(q) to Z/(pq) by the Chinese remainder theorem, and [a]^{k} and [a]ₖ denote first k-bits and last k-bits of a, respectively.

35. The communication method using public key cryptosystem according to claim 34, comprising the step of:
generating and publicizing the public information (n,k,k₀,k₁,α,G,H) by the receiver device.

36. The communication method using public key cryptosystem according to claim 34, for α=β=1, deleting α and β from the public key and the secret key, respectively.

37. The communication method using public key cryptosystem according to claim 34, comprising the step of:
sending the plaintext or the identification information of x along with ciphertext, or creating the plaintext m or x from publicized identification information.

38. The communication method using public key cryptosystem according to claim 37, comprising the step of:
decrypting the plaintext m or the x from the ciphertext using the identification information sent along with the ciphertext or the publicized identification information.

39. The communication method using public key cryptosystem according to claim 1, comprising the step of:
creating ciphertext C by
C=m^{2α} mod n,
and creating m_{1,p} and m_{1,q} by
$${m}_{1 , p} = {C}^{\frac{( p + 1 ) β }{4}} mod p , \\ {m}_{1 , q} = {C}^{\frac{( q + 1 ) β}{4}} mod q$$

40. The communication method using public key cryptosystem according to claim 22, comprising the step of:
creating ciphertext C by
C=x^{2α} mod n,
and creating m_{1,p} and m_{1,q} by
$${m}_{1 , p} = {C}^{\frac{( p + 1 ) β }{4}} mod p , \\ {m}_{1 , q} = {C}^{\frac{( q + 1 ) β}{4}} mod q$$

41. A program product, comprising:
a program for instructing a computer to execute one of the key generating step, the encrypting step, and the decrypting step which are described in claim 1; and
a medium embodying the program.

42. A communication system using public key cryptosystem which comprises a sender device and a receiver device and in which the sender device encrypts send data using a receiver's public key,
wherein the receiver device, using an operation unit the receiver device has, executes the key generating step described in claim 1 and generates the secret key (p,q,β) and the public key (n,k,α),
wherein the sender device, using an operation unit the sender device has, executes the encrypting step described in claim 1, computes Jacobi's symbol a=(m/n), and sends ciphertext (C,a) to the receiver device, and
wherein the receiver device, using the operation unit the receiver device has, executes the decrypting step described in claim 1 and obtains plaintext m.

43. The communication system using public key cryptosystem according to claim 4, wherein the receiver device comprises a device that generates the secret keys p and q by p=2p′+1 and q=2q′+1, where p′ and q′ are prime integers.

44. The communication system using public key cryptosystem according to claim 4, wherein the sender device comprises a device that generates the plaintext m so as to include check information for checking whether message text to be sent to the receiver has been correctly decrypted.

45. The communication system using public key cryptosystem according to claim 4,
wherein the device of the sender device to encrypt the plaintext m provides predetermined redundancy to the message text to be sent to the receiver and produces the contents of the resulting message text as the plaintext m, and
wherein the device of the receiver device to decrypt the plaintext m checks the predetermined redundancy.

46. The communication system using public key cryptosystem according to claim 4,
wherein the sender device comprises the step of providing a predetermined, meaningful message to the message text to be sent to the receiver and producing the contents of the resulting message text as the plaintext m, and encrypting the plaintext m by the method described in claim 4, and
wherein the receiver device comprises the step of decrypting the plaintext m by the method described in claim 4, and checking the contents of the predetermined, meaningful message.

47. The communication system using public key cryptosystem in claim 4, wherein the value of d (d>1) is variable.
